(19) United States
(12) Patent Application Publication
(10) Pub. No.: US 2009/0162028 A1
(43) Pub. Date: Jun. 25, 2009

(54) INFORMATION PROCESSING APPARATUS

(75) Inventor: Sayoko Tanaka, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/336,405

(22) Filed: Dec. 16, 2008

(30) Foreign Application Priority Data
Dec. 25, 2007 (JP) 2007-332518

(51) Int. Cl. H04N 5/91

(52) U.S. Cl. 386/83

(57) ABSTRACT

An information processing apparatus includes: a memory that stores schedule information that indicates a start time, an end time, and an event name for each of events; and a processor that operates to: obtain first video management information from an external video recorder, the first video management information indicating a recording start time and a recording end time for each of videos recorded by the external video recorder; determine the videos having the recording start time and the recording end time within the start time and the end time for each of the events by referring to the schedule information and the first video management information; and generate a second video management information from the first video management information by appending the event name to the determined videos.

### CROSS-REFERENCE TO RELATED APPLICATIONS

This application is based upon and claims the benefit of priority from Japanese Patent Application No. 2007-332518, filed on Dec. 25, 2007, the entire content of which are incorporated herein by reference.

### BACKGROUND

1. Field

One embodiment of the present invention relates to an information processing apparatus.

2. Description of the Related Art

Conventionally, there is proposed an information processing apparatus that displays character strings contained in previously entered schedule information as title candidates and allows the user to select one from among the character strings when the user enters a title, as video management information, to video information captured with a video camera. An example of such apparatus is disclosed in JP-T-2007-528626 (counterpart U.S. publication is: US 2007/0206921 A1).

The information processing apparatus has a storage unit for storing schedule information of a person having a possibility that he or she will be captured as video information and schedule information concerning yearly events, etc., a display unit for displaying video and a title selection menu, and a control unit, when a title is given to video information, for calling the schedule information, retrieving an event to which the video information photographing date and time correspond from the schedule information and displaying the character string contained in the event on the title selection menu on the display unit as a title candidate of the video information. The control unit sets the character string selected by the user out of the title selection menu as the title of the video information, so that the user can set the title of the video information without entering any character string and work load of video edit can be lightened.

The information processing apparatus in the related art enables the user to give a title to video information by performing easy work and thus if a plurality of pieces of video information exist, the listing property improves as the user references the titles. However, if the user classifies and edits video information in such a manner that he or she classifies a plurality of pieces of video information according to a plurality of themes and generates a video information collection for each theme, the user needs to check the video information or the titles one by one to find out the video information matching any desired theme; the user requires an enormous time for managing the video information.

### SUMMARY

According to a first aspect of the present invention, there is provided an information processing apparatus including: a memory that stores schedule information that indicates a start time, an end time, and an event name for each of events; and a processor that operates to: obtain first video management information from an external video recorder, the first video management information indicating a recording start time and a recording end time for each of videos recorded by the external video recorder; determine the videos having the recording start time and the recording end time within the start time and the end time for each of the events by referring to the schedule information and the first video management information; and generate a second video management information from the first video management information by appending the event name to the determined videos.

According to a second aspect of the present invention, there is provided an information processing apparatus including: a memory that stores schedule information that indicates a start time, an end time, and an event name for each of events; and a processor that operates to: obtain first video management information from an external video recorder, the first video management information indicating a recording start time and a recording end time for each of videos recorded by the external video recorder, wherein the recording start time and the recording end time being within the start time and the end time of a selected event that is selected from among the events included in the schedule information stored in the memory; and generate a second video management information from the first video information by appending the event name to the videos indicated by the first video management information.

According to a third aspect of the present invention, there is provided an information processing apparatus including a processor that operates to: obtain schedule information and first video management information from an external video recorder, the schedule information indicating a start time, an end time, and an event name for each of events, the first video management information indicating a recording start time and a recording end time for each of videos recorded by the external video recorder; determine the videos having the recording start time and the recording end time within the start time and the end time for each of the events by referring to the schedule information and the first video management information; and generate a second video management information from the first video management information by appending the event name to the determined videos.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a perspective view to show a personal computer (PC) as an information processing apparatus according to a first embodiment of the invention.

FIG. 2 is a block diagram to show the configuration of the PC and a video camera according to the first embodiment of the invention.

FIGS. 3A and 3B are schematic drawings to show schedule information according to the first embodiment of the invention.

FIG. 4 is a schematic drawing to show video management information according to the first embodiment of the invention.

FIG. 5 is a schematic drawing to show media video management information according to the first embodiment of the invention.

FIG. 6 is a flowchart to show an operation example of the PC according to the first embodiment of the invention.

FIG. 7 is a flowchart to show an operation example of the PC according to the first embodiment of the invention.

FIG. 8 is a flowchart to show an operation example of the PC according to the first embodiment of the invention.

FIG. 9 is a perspective view to show a DVD writer as an information processing apparatus according to a second embodiment of the invention.

FIG. 10 is a block diagram to show the configuration of the DVD writer and a mobile terminal according to the second embodiment of the invention.

### DETAILED DESCRIPTION

Embodiments of an information processing apparatus of the invention will be discussed with reference to the accompanying drawings.

### First Embodiment

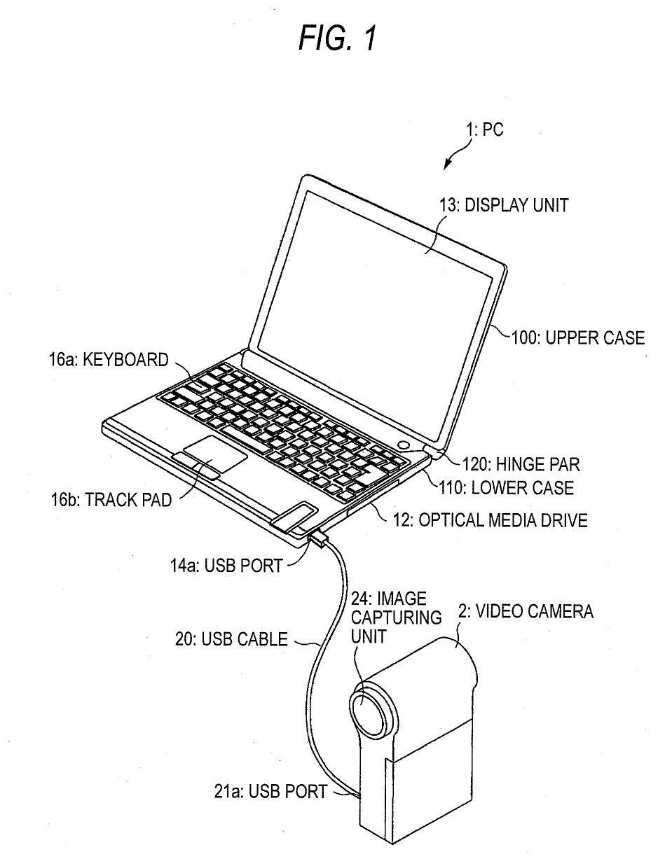

FIG. 1 is a perspective view to show a personal computer (PC) as an information processing apparatus according to a first embodiment of the invention.

A PC 1 is configured to be connectable to a video camera 2 by a USB (Universal Serial Bus) cable 20 for establishing communications therebetween and video information captured with the video camera 2 can be transferred to the PC 1 and the video camera 2 can be operated by the PC 1.

The PC 1 includes an upper case 100 and a lower case 110, and the upper case 100 is connected to the lower case 110 by a hinge part 120 so that it can be opened and closed. The upper case 100 has a display unit 13 implemented as a liquid crystal display panel, etc., for displaying text, an image, etc. The lower case 110 houses electronic components of a CPU (Central Processing Unit), an HDD (Hard Disk Drive), etc., and has on a top face an optical media drive 12 capable of reading and writing, such as a DVD or an HD DVD, a USB port 14a to which the USB cable 20 is connected for communicating with an external devices, a keyboard 16a for entering a character and a command, and a track pad 16b as a pointing device.

The video camera 2 has an image capturing unit 24 including an optical system having a plurality of lens groups and an image pickup device such as a CCD (Charge Coupled Device) and a USB port 21a into which the USB cable 20 is inserted for communicating with an external machine, and stores video information generated, when the image is captured, in a storage unit provided in the main unit of the video camera and video management information (first video management information) associated with the video information in the storage unit.

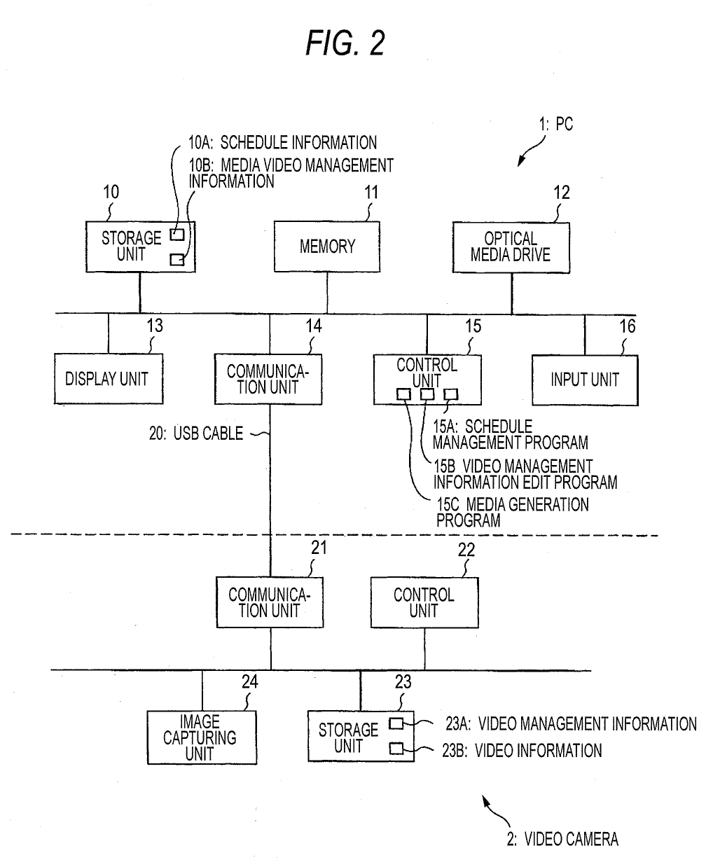

FIG. 2 is a block diagram to show the configuration of the PC and the video camera according to the first embodiment of the invention.

The PC 1 has a storage unit 10 such as an HDD for storing information, memory 11 for temporarily storing information and aiding in processing of the sections, the above-mentioned optical media drive 12 capable of reading and writing information from and onto an optical recording medium of a DVD or an HD DVD, the above-mentioned display unit 13 for displaying text and an image on a liquid crystal display (LCD) panel, etc., a communication unit 14 for communicating with the video camera 2 through the USB cable 20 inserted into the USB port 14a, a control unit 15 for controlling the operation of the sections and operating a program, and an input unit 16 including switches to which operation functions are assigned including the keyboard 16a and the track pad 16b.

The storage unit 10 stores schedule information 10A including the event name, date information, etc., set for each event and media video management information 10B (second video management information) as information associated with video information when the video information is written onto a record medium in the optical media drive 12.

The control unit 15 runs a schedule management program 15A for editing the schedule information 10A, a video management information edit program 15B for editing the media video management information 10B, and a media generation program 15C for controlling the optical media drive 12 when video information and the media video management information 10B are written onto a record medium.

The video camera 2 has a communication unit 21 for communicating with the PC 1 through the USB cable 20 inserted into the USB port 21a, a control unit 22 for controlling the operation of the sections, the above-mentioned image capturing unit 24 including an optical system including a plurality of lens groups and an image pickup device such as a CCD, and a storage unit 23 of a detachable SD card, etc., for storing information. The video camera 2 also has an input unit (not shown) for executing photographing operation of the image capturing unit 24, menu operation of an image pickup program (not shown) operating in the control unit, etc.

The storage unit 23 stores video management information 23A of associated information with video information 23B, such as the photographing date and the photographing start and end times with the video camera 2, for example, an IFO file, etc., and the video information 23B of real data of video captured in the image capturing unit 24.

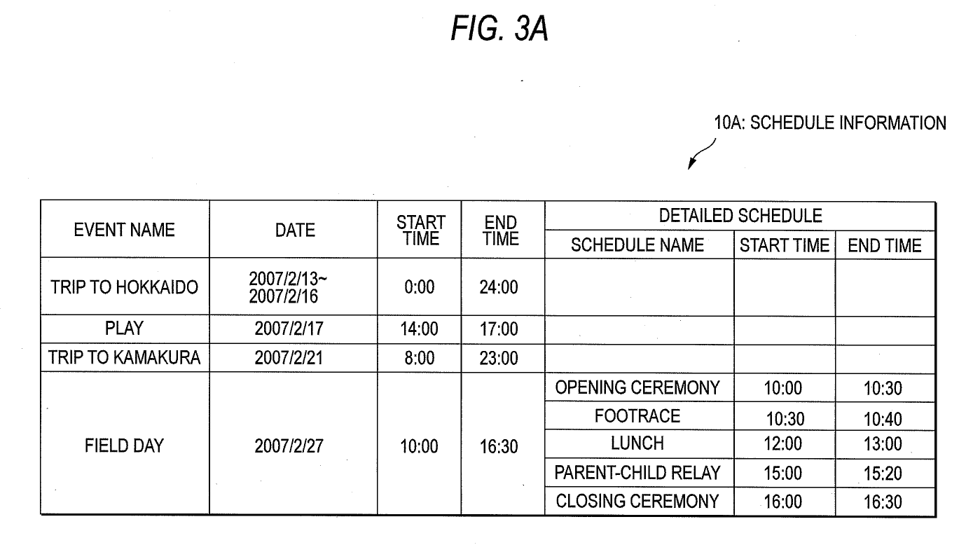

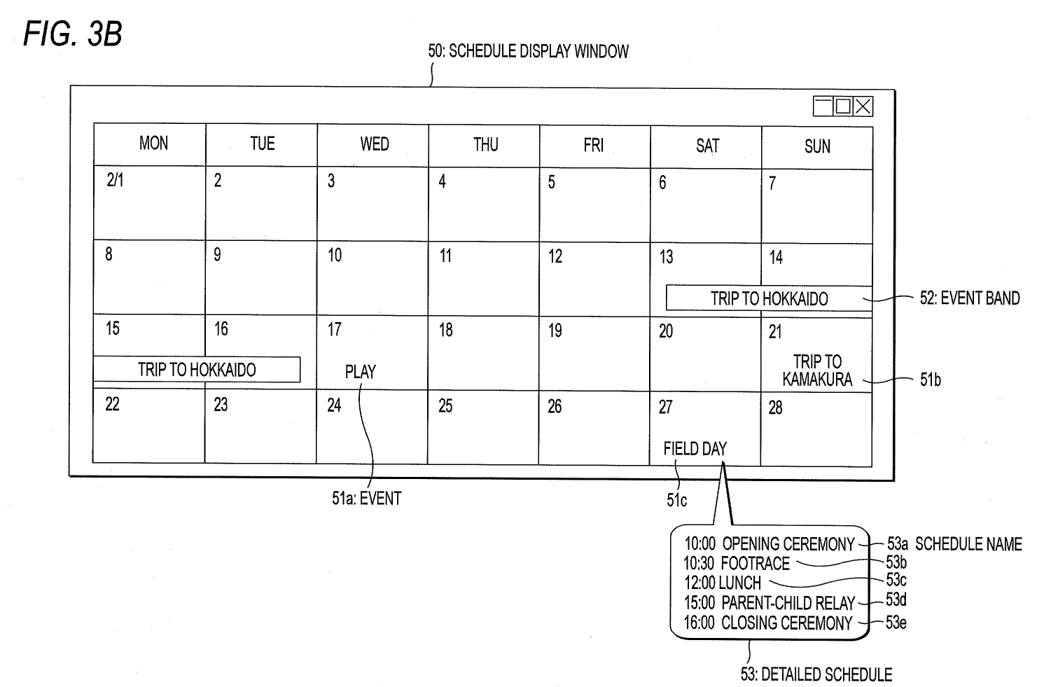

FIGS. 3A and 3B are schematic drawings to show schedule information according to the first embodiment of the invention.

The schedule information 10A has an event name entered by the user and indicating the name of an event, a date on which the event is scheduled to be executed, a start time at which the event is scheduled to be started, an end time at which the event is scheduled to be ended, and detailed schedule data that can be set in the event, as shown in FIG. 3A. The detailed schedule data is entered by the user and has a schedule name indicating the name of a schedule, the start time of the schedule, and the end time of the schedule.

A schedule display window 50 is displayed on the display unit 13 by the schedule management program 15A based on the schedule information 10A; it displays events 51a to 51c each displayed only as the event name for an event not across days, an event band 52 displayed as a band with the event name for an event across days, a detailed schedule 53 for displaying schedule names, for example, as popup display for the detailed schedule data, and schedule names 53a to 53e each displayed together with the start time of the detailed schedule, as shown in FIG. 3B. Not only the monthly display, but also weekly display and daily display may be produced.

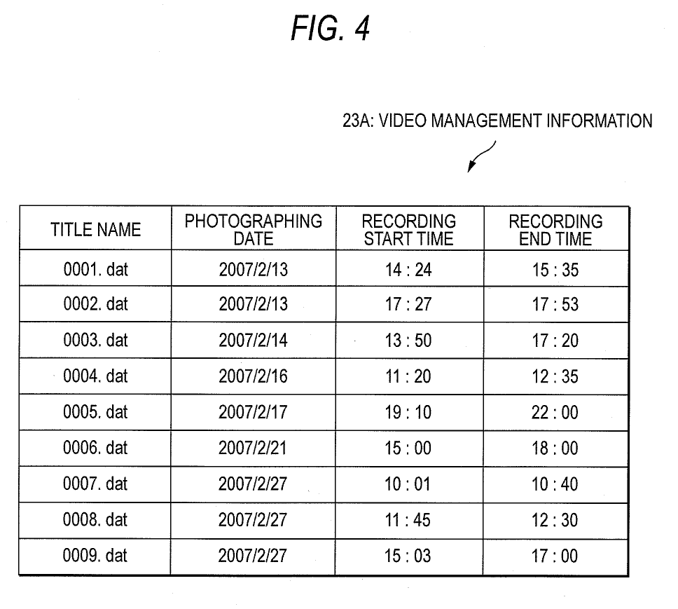

FIG. 4 is a schematic drawing to show video management information according to the first embodiment of the invention.

The video management information 23A has a title name for video information, a photographing date on which the video information was captured, a photograph start time, and a recording end time. The title name is given automatically by the control unit 22 at the photographing time; generally it is set using the number of photographing times, etc. The photographing date, the photograph start time, and the recording end time are given automatically at the photographing time based on a clock contained in the control unit 22.

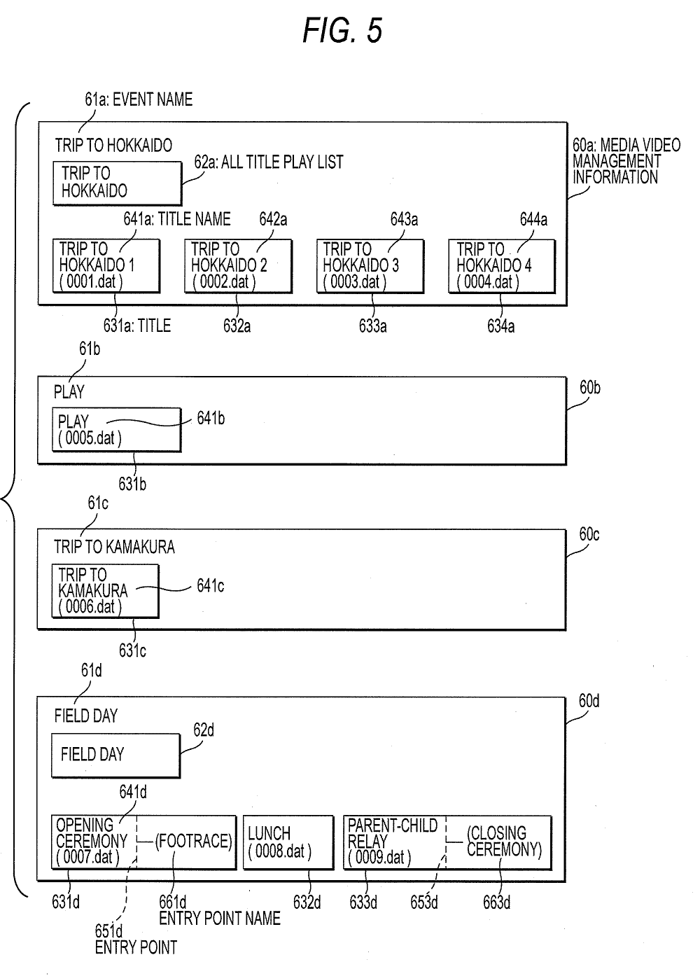

FIG. 5 is a schematic drawing to show media video management information according to the first embodiment of the invention.

Media video management information 60 (60a to 60d) has an event name (61a to 61d) displayed as a name when the media video management information 60 is used to record video information on a record medium, one or more titles 630 (631a to 633d) set for each video management unit, and an all title event list 62 (62a to 62d) as playback order information describing the playback order of the titles 630. The all title event list 62 is generated when two or more titles 630 exist. The title 630 has a title name 640 (641a to 643d). An entry point 650 (651d, 653d) as reference information like a bookmark or a chapter can be set for the title 630.

The media video management information 60a has an event name 61a acquired from the event name “Trip to Hokkaido” of the schedule information 10A, an all title play list 62a describing the playback order of titles, titles 631a to 634a corresponding to titlenames “0001.dat” to “0004.dat” of the video management information 23A with the recording start time to the recording end time contained between the start time and the end time of “Trip to Hokkaido,” namely, between “0:00” on “Feb. 13, 2007” and “24:00” on “Feb. 16, 2007” and title names 641a to 644a with serial numbers 1 to 4 given to the event name “Trip to Hokkaido” of the schedule information 10A.

The media video management information 60b has an event name 61b acquired from the event name “Play” of the schedule information 10A, a title 631b corresponding to a title name “0005.dat” of the video management information 23A contained between the start time and the end time of “Play,” and a title name 641b using the event name “Play.” The media video management information 60b is only the title 631b and thus does not have an all title play list describing the title playback order.

The media video management information 60c has an event name 61c acquired from the event name “Trip to Kamakura” of the schedule information 10A, a title 631c corresponding to a title name “0006.dat” of the video management information 23A contained between the start time and the end time of “Trip to Kamakura,” and a title name 641c using the event name “Trip to Kamakura.”

The media video management information 60d has an event name 61d acquired from the event name “Field day” of the schedule information 10A, an all title play list 62d describing the playback order of titles, titles 631d to 633d corresponding to title names “0007.dat” to “0009.dat” of the video management information 23A with the recording start time to the recording end time contained between the start time and the end time of “Field day,” namely, between “10:00” on “Feb. 27, 2007” and “16:30”, and title names 641d to 643d given detailed schedule data “Opening ceremony,” “Lunch,” and “Parent-child relay” of the schedule information 10A. Since the start times and the end times of the schedule names “Footrace” and “Closing ceremony” are contained in the titles 631d and 633d given the title name 641d “Opening ceremony” and the title name 643d “Parent-child relay,” the start times are set as entry points 651d and 653d and entry point names 661d “Footrace” and 663d “Closing ceremony” are given.

The operation of the PC according to the first embodiment of the invention will be discussed with reference to the accompanying drawings.

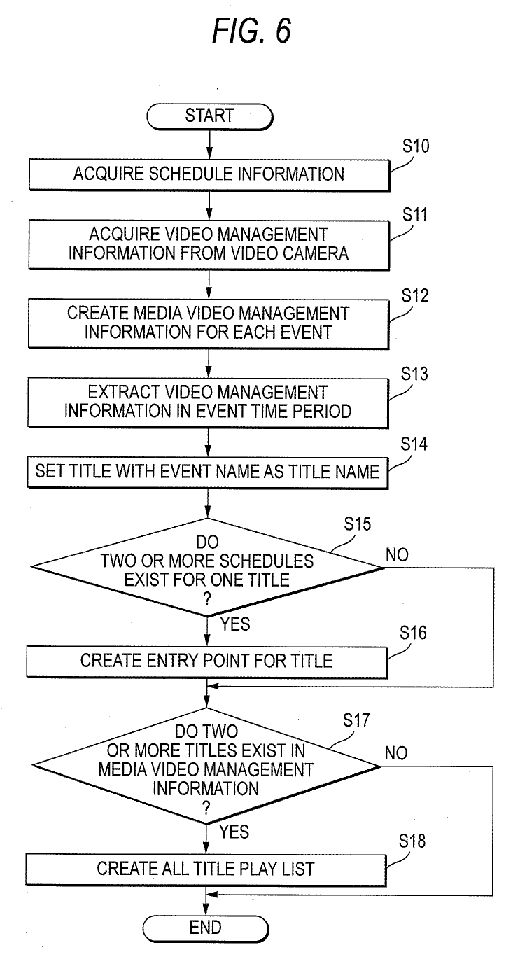

FIG. 6 is a flowchart to show an operation example of the PC according to the first embodiment of the invention.

To begin with, the video management information edit program 15B acquires the schedule information 10A from the storage unit 10 (S10) and acquires the video management information 23A from the video camera 2 through the communication unit 14 (S11).

Next, the video management information edit program 15B generates media video management information 10B in the storage unit 10 for each event of the schedule information 10A (S12), extracts the video management information 23A with the photographing time period between the recording start time and the recording end time or at least a part of the photographing time period contained in the event time period between the start time and the end time of the event (S13), and sets the extracted video management information 23A in the media video management information 10B as a title (S14).

At this time, the event name is used as the title name of the title and if more than one title exists, serial numbers are given to the event names. If a detailed schedule is set, the schedule name contained in the schedule time period between the start time and the end time of the schedule is given to the title name.

If two or more schedules exist for one title (YES at S15), the video management information edit program 15B adopts the schedule name of the oldest schedule as the title name of the title, generates entry points for titles for other schedules, and sets the schedule name as the entry point name (S16).

Next, if the extracted video management information 23A, namely, two or more titles exist for one piece of the media video management information 10B (YES at S17), the video management information edit program 15B generates an all title play list so as to play back the extracted titles in the time order (S18).

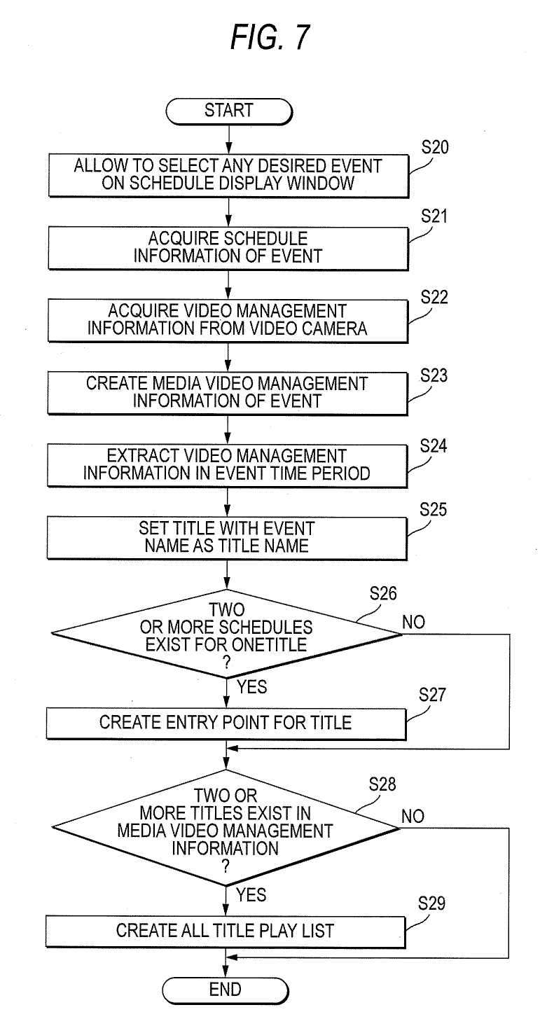

FIG. 7 is a flowchart to show an operation example of the PC according to the first embodiment of the invention.

First, the schedule management program 15A acquires the schedule information 10A from the storage unit 10 and displays the schedule display window 50 shown in FIG. 3B. If the user selects any desired event (S20), the schedule management program 15A acquires the schedule information 10A of the selected event (S21) and acquires the video management information 23A from the video camera 2 through the communication unit 14 (S22).

Next, the schedule management program 15A generates media video management information 10B of the selected event in the storage unit 10 (S23), extracts the video management information 23A with the photographing time period or at least a part of the photographing time period contained in the event time period (S24), and sets the extracted video management information 23A in the media video management information 10B as a title (S25).

If two or more schedules exist for one title (YES at S26), the schedule management program 15A adopts the schedule name of the oldest schedule as the title name of the title, generates entry points for titles for other schedules, and sets the schedule name as the entry point name (S27).

Next, if the extracted video management information 23A, namely, two or more titles exist for one piece of the media video management information 10B (YES at S28), the schedule management program 15A generates an all title play list so as to play back the extracted titles in the time order (S29).

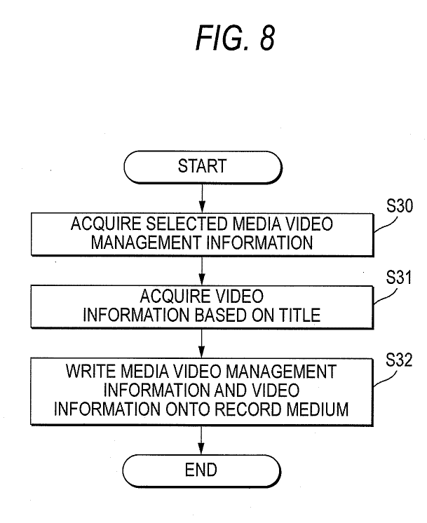

FIG. 8 is a flowchart to show an operation example of the PC according to the first embodiment of the invention.

The media generation program 15C displays the media video management information 60 shown in FIG. 5 on the display unit 13 and requests the user to select any desired media video management information 60. At this time, only the event names may be displayed on the display unit 13 for requesting the user to select any desired media video management information 60. Next, the media generation program 15C acquires the selected media video management information 60 (S30) and acquires the corresponding video information 23B from the video camera 2 through the communication unit 14 based on the title of the acquired media video management information 60 (S31). Next, the media generation program 15C writes the media video management information 60 and the video information 23B onto an external record medium in the optical media drive 12 (S32).

According to the first embodiment described above, information is extracted from the video management information 23A of the video camera 2 based on the schedule information 10A to create the media video management information 10B, so that a title name can be given to the video information 23B captured with the video camera 2, the video information 23B can be recorded collectively on a record medium for each event, and management of the video information 23B is facilitated.

The video management information 23A and the video information 23B may be acquired not only from the video camera 2, but also from external storage, etc., or may be information stored in the storage unit 10 of the PC 1. Information may be recorded based on the media video management information 60 not only on an external record medium, but also in the storage unit 10.

The media video management information 60 is generated in event units and may be divided into pieces based on the capacity of the record medium to record the media video management information 60. A plurality of pieces of the media video management information 60 may be unified based on the capacity of the record medium to record the media video management information 60.

### Second Embodiment

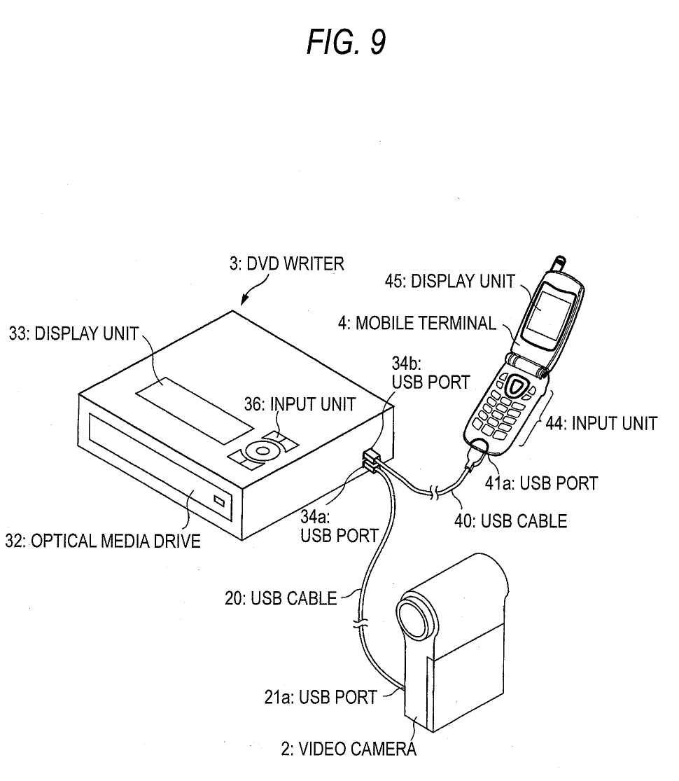

FIG. 9 is a perspective view to show a DVD writer as an information processing apparatus according to a second embodiment of the invention. Parts having the same configuration and function as those of the first embodiment are denoted by the same reference numerals in the description that follows.

A DVD writer 3 can be connected to a video camera 2 by a USB (Universal Serial Bus) cable 20 for communicating information with each other and video information captured with the video camera 2 can be transferred to a PC 1 and the video camera 2 can be operated by the PC 1. The DVD writer 3 can also be connected to a mobile terminal 4 by a USB cable 40 for communicating information with each other and can reference the information stored in the mobile terminal 4.

The DVD writer 3 houses electronic components of a CPU, an HDD, etc., and has on a top face an optical media drive 32 capable of reading and writing, such as a DVD or an HD DVD, a display unit 33 implemented as a liquid crystal display panel, etc., for displaying text, an image, etc., a USB port 34a to which the USB cable 20 is connected for communicating with an external machine, and an input unit 36 for operating the function of the DVD writer 3.

The mobile terminal 4 has a control unit and a storage unit in the main body of the mobile terminal 4 and also has a USB port 41a to which the USB cable 40 is connected for communicating with the DVD writer 3, an input unit 44 for operating the function of the mobile terminal 4, and a display unit 45 implemented as a small-sized liquid crystal display panel, etc., for displaying text, an image, etc. The mobile terminal 4 includes a schedule management function and enables the user to enter an event and a schedule through the input unit 44.

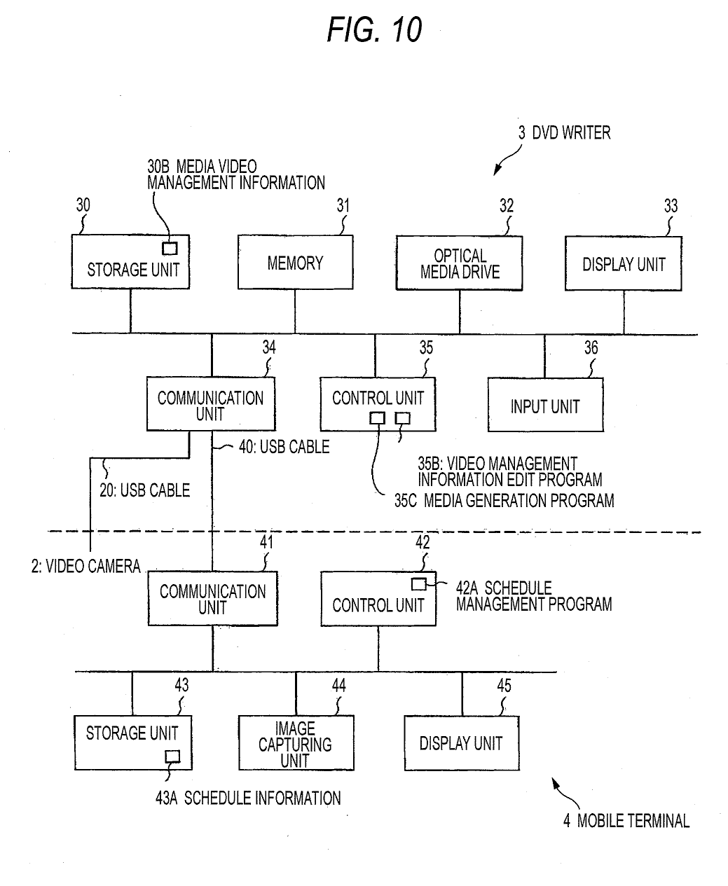

FIG. 10 is a block diagram to show the configuration of the DVD writer and the mobile terminal according to the second embodiment of the invention.

The DVD writer 3 has a storage unit 30 such as an HDD for storing information, memory 31 for temporarily storing information and aiding in processing of the sections, the above-mentioned optical media drive 32 capable of reading and writing information from and onto an optical recording medium of a DVD or an HD DVD, the above-mentioned display unit 33 for displaying text and an image on a liquid crystal display (LCD) panel, etc., a communication unit 34 for communicating with the video camera 2 and the mobile terminal 4 through the USB cables 20 and 40 inserted into USB ports 34a and 34b, a control unit 35 for controlling the operation of the sections and operating a program, and an input unit 36 including switches to which operation functions are assigned.

The storage unit 30 stores media video management information 30B as information associated with video information when the video information is written onto a record medium in the optical media drive 32.

The control unit 35 operates a video management information edit program 35B for editing the media video management information 30B and a media generation program 35C for controlling the optical media drive 32 when video information and the media video management information 30B are written onto a record medium.

The mobile terminal 4 has a communication unit 41 for communicating with the DVD writer 3 through the USB cable 40 inserted into the USB port 41a, a control unit 42 for controlling the operation of the sections, a storage unit 43 of a detachable SD card, etc., for storing information, an input unit 44 for executing menu operation, etc., of a telephone function program (not shown) operating in the control unit 42, and the above-mentioned display unit 45 for displaying text and an image on the liquid crystal display (LCD) panel.

The control unit 42 stores a schedule management program 42A for editing schedule information 43A.

The storage unit 43 stores the schedule information 43A including the event name, date information, etc., set for each event.

The video management information edit program 35B acquires the schedule information 43A from the storage unit 43 of the mobile terminal 4 and also acquires the video management information 23A from the video camera 2. The video management information edit program 35B generates media video management information 30B based on the schedule information 43A and the video management information 23A.

According to the second embodiment described above, the media video management information 30B is generated based on the schedule information 43A acquired from the mobile terminal 4, so that if the DVD writer 3 as an information processing apparatus does not have the schedule management program 42A, similar advantages to those of the first embodiment can be achieved.

What is claimed is:

1. An information processing apparatus comprising:
a memory configured to store schedule information indicative of a start time, an end time, and an event name of an event; and
a processor configured to obtain first video management information from an external video recorder, the first video management information indicative of a recording start time and a recording end time of a video recorded by the external video recorder, configured to determine the video comprising the recording start time and the recording end time within the start time and the end time for the event by referring to the schedule information and the first video management information, and configured to generate a second video management information from the first video management information by appending the event name to the determined video.

2. The apparatus of claim 1, wherein the processor further configured to obtain the video from the external video recorder based on the second video management information, and configured to control a storage device in order to store the obtained video with the second video management information on an external storage media.

3. The apparatus of claim 1, wherein the processor further configured to generate the second video management information from the first video management information by appending reference information for a plurality of sets of the schedule information when the plurality of sets of the schedule information is comprised in the first video management information.

4. The apparatus of claim 1, wherein the processor further configured to generate playback order information indicative of an order of playing back the video corresponding to a plurality of the first video management information when the plurality of sets of the first video management information is comprised in is the second video management information.

5. An information processing apparatus comprising:
a memory configured to store schedule information indicative of a start time, an end time, and an event name of events; and
a processor configured to obtain first video management information from an external video recorder, the first video management information indicative of a recording start time and a recording end time of the video recorded by the external video recorder, wherein the recording start time and the recording end time being within the start time and the end time of an event selected from among the events comprised in the schedule information stored in the memory, and configured to generate a second video management information from the first video information by appending the event name to the video indicated by the first video management information.

6. The apparatus of claim 5, wherein the processor further configured to obtain the video from the external video recorder based on the second video management information, and to control a storage device in order to store the obtained video with the second video management information on an external storage media.

7. The apparatus of claim 5, wherein the processor further configured to generate the second video management information from the first video management information by appending reference information for a plurality of sets of the schedule information when the plurality of sets of the schedule information is comprised in the first video management information.

8. The apparatus of claim 5, wherein the processor further configured to generate playback order information indicative of an order of playing back the video corresponding to a plurality of sets of the first video management information when the plurality of sets of the first video management information is comprised in the second video management information.

9. An information processing apparatus comprising a processor configured to obtain schedule information and first video management information from an external video recorder, the schedule information indicative of a start time, an end time, and an event name of an event, the first video management information indicative of a recording start time and a recording end time for the video recorded by the external video recorder, configured to determine the video having the recording start time and the recording end time within the start time and the end time for the event by referring to the schedule information and the first video management information, and configured to generate a second video management information from the first video management information by appending the event name to the determined video.

10. The apparatus of claim 9, wherein the processor further configured to obtain the video from the external video recorder based on the second video management information, and to control a storage device in order to store the obtained video with the second video management information on an external storage media.

11. The apparatus of claim 9, wherein the processor further configured to generate the second video management information from the first video management information by appending reference information for referring to a plurality of sets of the schedule information when the plurality of sets of the schedule information is comprised in the first video management information.

12. The apparatus of claim 9, wherein the processor further configured to generate playback order information indicative of an order for playing back the video corresponding to a plurality of sets of the first video management information when a plurality of sets of the first video management information is comprised in the second video management information.
